(19) United States
(12) Patent Application Publication
(10) Pub. No.: US 2006/0147027 A1
(43) Pub. Date: Jul. 6, 2006

(54) Switching matrix with two control inputs and a hold input at each switching element

(76) Inventor: Georg Rauh, Zirndorf (DE)

Correspondence Address: SCHIFF HARDIN, LLP;PATENT DEPARTMENT, 6600 SEARS TOWER, CHICAGO, IL, 60606-6473, US

(21) Appl. No.: 11/283,430

(22) Filed: Nov. 18, 2005

(30) Foreign Application Priority Data
Nov. 19, 2004 (DE) 10 2004 055 937.6

(51) Int. Cl. H04M 3/00

(52) U.S. Cl. 379/279

(57) ABSTRACT

A switching matrix has a first number of inputs and a second number of outputs with a conductor arrangement and controllable switching elements by means of which the inputs can be connected with the outputs. The switching matrix has a first number of control lines and a second number of hold lines. Each switching element is connected with at least two control lines and at least one hold line. The control lines supply a switching signal to the switching element, by means of which switching signal one of the inputs is connected with one of the outputs by the switching element. The hold line supplies a hold signal to the switching element via which the connection between the respective input and the respective output is maintained.

### BACKGROUND OF THE INVENTION

1. Field of the Invention

The present invention concerns a switching matrix of the type having a first number of inputs and a second number of outputs with a conductor arrangement and controllable switching elements by means of which the inputs can be selectively connected with the outputs.

2. Description of the Prior Art

In the transmission of electrical signals, it is frequently necessary to route a number of input signals. For example, a switching matrix is necessary to route magnetic resonance signals acquired by a number of local coils to corresponding receivers. In general, all local coils are not always simultaneously located in a homogeneity volume of the magnetic resonance apparatus and thus each coil does not always receive a magnetic resonance signal. Furthermore, the number of local coils frequently exceeds the available analog/digital converters that convert the signal for further processing. It is therefore necessary to use a switching matrix so that the local coils can be variably connected with the analog/digital converters. For example, there are magnetic resonance apparatuses with 32 acquisition channels to which analog/digital converters are connected. If 64 local coils for examination of a patient are positioned in an examination, the local coils are variably connected with the 32 analog/digital converters by the switching matrix.

The switching matrix can be realized as a distributor network that is composed of conductors that lead from the local coils to the acquisition channels and are arranged in rows and columns. At each intersection point of the various lines, a controllable switch is present that can connect or separate the corresponding intersecting lines and thus connect the respective local coil with the respective analog/digital converter. In the example of 64 local coils and 32 acquisition channels, 2,048 controllable switching elements are necessary. One possibility for the realization of such a switching matrix is the use of semiconductor technology. Each switch can be formed by semiconductor components, with one to three semiconductor components being necessary for each switch. Capacitors and coils are still additionally used to separate the control signal of the switch from the radio-frequency voltage to be switched. In total, more than 10,000 individual semiconductor elements are required to realize such a switching matrix. It is additionally necessary to activate each switch in the switching element by means of a separate control line via which the control signal is supplied. A control unit is necessary for each control line for generation of the control signals. Such a high number of control units can not be realized on one chip even in customer-specific integrated circuits.

A further possibility for the realization of controllable switches is micro-electromechanical components (MEM). In particular electromechanical relays or switches are of interest for the application in the switching matrix. Because such switches close the conductors via a mechanical contact, they exhibit a good linearity in terms of their analog signal transfer performance. The use of such components, however, also requires a separate control line and a control unit.

### SUMMARY OF THE INVENTION

An object of the present invention is to provide a switching matrix in which a number of controllable switching elements can be controlled with little effort.

This object is achieved by a switching matrix wherein a switching element connects one of the inputs with one of the outputs via switching signals at the two control lines, and each switching element is further to a hold line that supplies a signal to maintain the connection produced by the switching element. It is thus possible to design the control lines as a matrix, whereby a large number of conductors can be spared. In such an arrangement each switching element is connected with at least two control lines, but it only switches (changes state) when a control signal is applied via both lines. The number of control lines in the example of 64 acquisition channels and 32 local coils is thereby reduced from 2,049 to 96, which entails a drastic simplification of the manufacture of such a switching matrix. By the transmission of a hold signal on the hold line, the connection between the respective input and the respective output is maintained after deactivation of the switching signal. Multiple switching elements whose switch state is maintained by the hold signal thus can be sequentially closed in the switching matrix. For example, in this manner it is possible to connect each output with one of the inputs and thus, if applicable, to simultaneously transfer a number of signals.

In an embodiment, the switching element has a micro-electromechanical switch. This type of switch offers the advantage of a good linearity in terms of its analog signal transfer performance since such switches close the conductors via a mechanical contact.

### DESCRIPTION OF THE DRAWINGS

FIG. 1 is a schematic illustration of a switching matrix in accordance with the invention.

FIG. 2 is an exemplary embodiment of an inventive micro-electromechanical switching element.

FIG. 3 shows an alternative embodiment of the inventive switching matrix.

FIG. 4 shows an alternative embodiment of the micro-electromechanical switching element.

### DESCRIPTION OF THE PREFERRED EMBODIMENTS

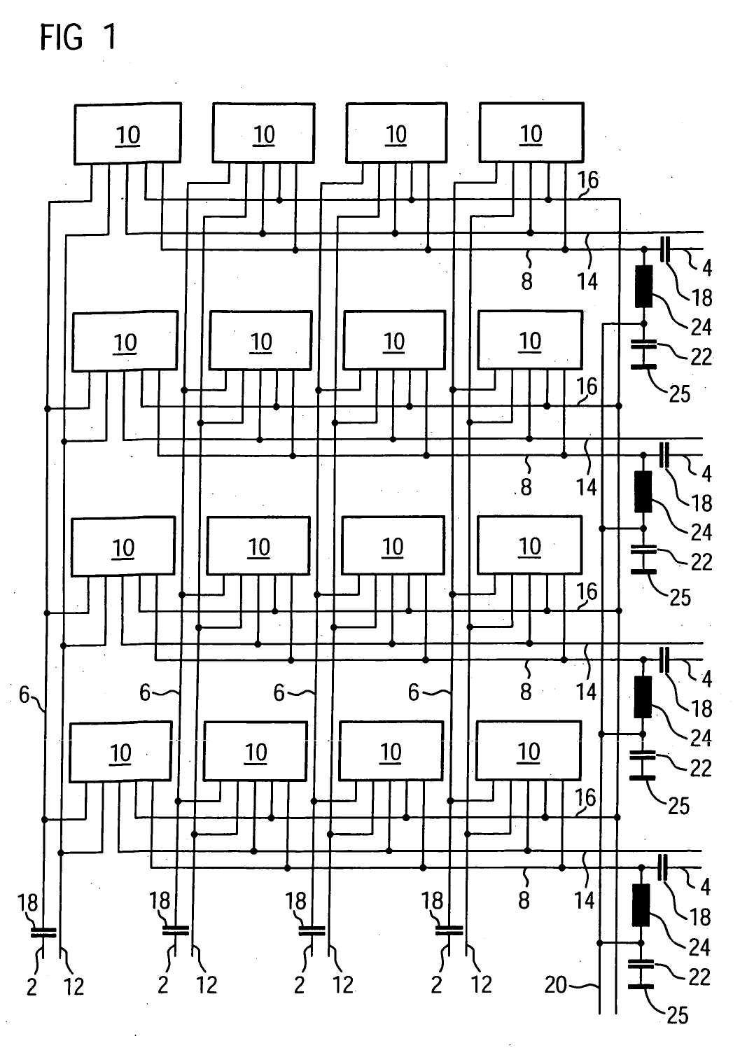

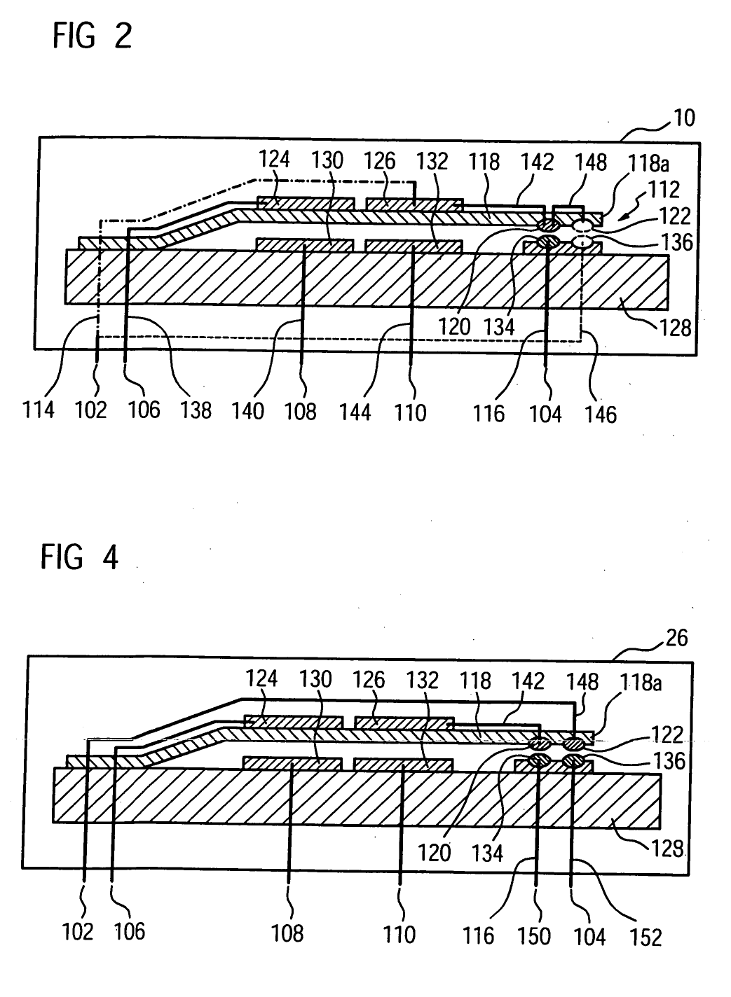

FIG. 1 shows a switching matrix with a first number of inputs 2 and a second number of outputs 4. In the present example, four inputs 2 and four outputs 4 are shown. The shown switching matrix can be used, for example, for connection of local coils (not shown) of a magnetic resonance apparatus with corresponding analog-digital converters. In this case, the inputs 2 of the switching matrix would be connected with the local coil and the analog-digital converters would be connected with the outputs 4 of the switching matrix. The switching matrix has an electrical signal line 6 and 8 for each input 2 and each output 4, respectively the electrical signal lines 6 and 8 being arranged in the form of a matrix. The switching matrix furthermore has switching elements 10 by means of which the signal lines 6 of the inputs 2 can be connected with the signal lines 8 of the outputs 4, or can be separated therefrom. The design of the switching elements 10 is further described in detail below in connection with FIG. 2.

The switching matrix 2 has a number of electrical control lines 12 and 44 for control of the switching elements 10. The switching elements 10 are connected via the control lines 12 and 14 with control units (not shown in Figure) via which a switching voltage can be applied between the two control lines 12 and 14. The control units are individually actuatable (activatable) dependent on which inputs are desired to be connected to which outputs. The control lines 12 and 14 are arranged in a matrix structure analogous to the signal lines 6 and 8. All switching elements 10 arranged in a row are connected with a single control unit via one of the control lines 14. All switching elements 10 arranged one above the other in a column are likewise connected with a single control unit via one of the control lines 12. Each of the switching elements 10 is consequently connected with two of the control units

A switching voltage is applied between the two control lines 12 and 14 of the corresponding switching element 10 to connect one of the inputs 2 with one of the outputs 4, whereupon the switching element 10 closes and a connection is produced between the respective input 2 and the respective output 4. The switching voltage necessary to switch the switching element 10 is applied at one of the switching elements 10 due to the matrix arrangement of the control lines 12 and 14. It is thus ensured that each switching element 10 can be individually closed.

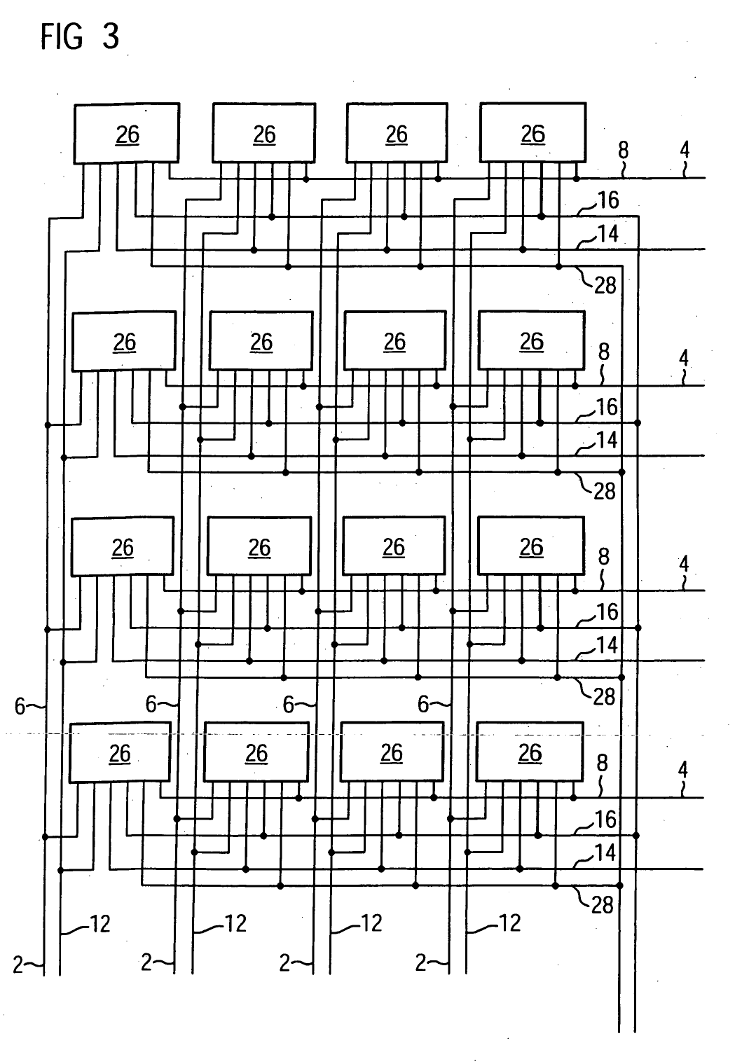

Each switching element 10 is connected with a further hold line 16 via which a hold voltage is supplied to the switching element 10. The switching element 10 can also remain closed after disconnection of the switching voltage due to the hold voltage. After closing of a switching element 10, the corresponding switching voltage can consequently be disconnected and a further switching element 10 of the switching matrix can be closed. The further switching element 10 is likewise supplied with the hold voltage and also remains closed after disconnection of the switching voltage. In this manner, multiple switching elements 10 can be sequentially closed one after another, whereby the switch state is respectively maintained by the hold voltage. The hold voltage is applied between the hold line 16 and the signal line 8. Since the hold voltage is a direct voltage and the signals to be transferred are RF signals in the case of a magnetic resonance apparatus, no interferences arise between the two signals transferred on the signal line. In FIG. 3 a further example of a switching matrix is shown that is also suitable for transfer of direct voltage signals. In FIG. 1, capacitive elements 18 are respectively arranged in the signal lines 6 and 8 to decouple the direct current path from the RF path. A feed line 20 serves to inject the hold voltage into the signal lines 8, the feed line 20 being connected in a known manner via LC modules, each formed by a capacitor 22 and a coil 24. The capacitor is arranged between the feed line 20 and a reference potential 25. Other known techniques for injecting a direct voltage into an RF path can be used. The functionality of the hold voltage within the switching elements 10 is explained in detail using FIG. 2.

A magnetic resonance measurement can be implemented after the local coils connected with the inputs of the switching matrix are connected with the respective analog/digital converters at the outputs 4 within a sequence switching event. The magnetic resonance signals acquired via the local coils are transferred to the analog/digital converter via the signal lines 6, the switching elements 10 and the signal lines 8 and can be evaluated. If the switching matrix should be switched differently for a following measurement, it is merely necessary to disconnect the hold voltage, whereupon all switching elements 10 can open and a new circuiting event can be initiated.

Due to the shown arrangement of the switching elements 10 and the functionality with switching and hold voltages described further below using FIG. 2, the number of the control units and control and hold lines 12, 14 and 16 is drastically reduced in comparison with a known crossbar distributor in which each switching element 10 is activated via a separate control unit with separate control line. In the switching matrix described here, the difference with ten (eight for the switching voltage, two for the hold voltage) as opposed to sixteen control units does in fact turn out to be small, but in general the number of the required control lines and control units reduces from m·n to m+n, whereby m is the number of the inputs 2 and n is the number of the outputs 4. In the example mentioned above of a magnetic resonance apparatus with sixty-four local coils and thirty-two analog/digital converters, the number of the required control units reduces from 2,048 to 96. The switching matrix thus can be completely realized within an integrated circuit, which previously could be accomplished only with great effort due to the requirement of control lines. It is thereby possible to integrate the capacitive elements 18 and LC modules with the switching elements 10 and the switching matrix in a circuit. Alternatively, it is possible to realize the capacitive elements and LC modules outside of the circuit.

FIG. 2 schematically shows a switching element 10 as used in the switching matrix according to FIG. 1. It has five connections for the signal lines 6 and 8, the control lines 12 and 14 and the hold line 16. A signal input 102 and a signal output 104, two connections 106 and 108 for the control lines 12 and 14 for impressing the switching voltage, and a hold connection 110 for the hold line 16 for impressing the hold voltage are provided. The hold voltage is fed back via the signal output 104. The switching element 10 has a micro-electromechanical switch 112 that is connected with the signal input 102 of the switching element 10 via a line [conductor] 114. As described in FIG. 1, in the switching matrix the signal input 102 is connected with one of the inputs 2 of the switching matrix via a signal line 6. The switch 112 is connected with the signal output 104 of the switching element 10 via a second line 116. In the switching matrix, the signal output 104 is connected with an output 4 via one of the electrical signal lines 8. Given a closed switch 112, an input of the switching matrix is consequently connected with one of the outputs 4. A local coil of a magnetic resonance apparatus that is connected with the input 2 can thus transfer magnetic resonance signals to an analog-digital converter connected with the output 4 of the switching matrix.

The switch 112 has a switch tongue 118 with a movable end 118a on which two contacts 120 and 122 are fashioned. Moreover, a switch contact 124 and a hold contact 126 are fashioned on the switch tongue 118. A substrate 128 is located beneath the switch tongue 118, on which substrate 128 are likewise fashioned a switch contact 130, a hold contact 132 and two contacts 134 and 136. The switch contact 120 of the switch tongue 118 is connected with a first control connection 106 of the switching element 10 via an electrical conductor 138. The switch contact 130 arranged beneath the switch tongue 118 is connected with a second control connection 108 via a conductor 140. If, as described above, a voltage is applied between both control connections 106 and 108, the switch tongue 118 is moved downwards and connects contacts 120 and 134 and contacts 122 and 136. An electrical connection between the respective input 2 of the switching matrix and the respective output 4 of the switching matrix is thus established.

The hold contact 126 of the switch tongue 118 is connected with the contact 120 on the switch tongue 118 via a conductor 142, and the corresponding counterpart of the contact 134 on the substrate 124 is connected with the signal output 104. The hold contact 132 located opposite the switch tongue 118 is connected with the hold connection 110 of the switching element 10 via a conductor 144. If a direct voltage is present between the hold contacts 126 and 132, the switch 112 also remains closed given a disconnected switching voltage. If the switch 112 is opened, due to the missing electrical contact between both contacts 120 and 134 the hold voltage does not effect a closing of the switch tongue 118 since it is not applied between both hold contacts 126 and 132, but rather is applied between the hold contact 132 and the contact 134. Only when the switch tongue is closed by a switching voltage between the switch contacts 124 and 130 is the hold voltage applied between the hold contacts 126 and 132 (through the closed contacts 120 and 134), whereby the switch 112 still remains closed given a disconnected switching voltage. To program the switching matrix, the hold voltage is consequently initially applied to all switching elements 10 and afterwards the desired switching elements 10 are sequentially closed via momentary application of a switching voltage.

There are two variants for the conduction of the magnetic resonance signal to be transferred from the signal input 102 of the switching element 10 to the signal output 104 via the switch tongue 118. First, it is possible to connect the signal input 102 with the hold contact 126 of the switch tongue via a conductor 114, such that this is furthermore connected with the signal output 104 via the contacts 120 and 134. This was already described above. Alternatively, it is possible to connect the signal input 102 with the contact 136 via a conductor 146 and to connect the contact 132 with the contact 120 via a conductor 148. An electrical contact with the signal output is thus established given a closed switch tongue 118.

FIG. 3 shows an alternative embodiment of the switching matrix with switching elements 26 modified slightly relative to FIG. 2. The internal design of the switching elements 26 used here is explained in further detail below using FIG. 4. Analogous to the embodiment shown in FIG. 1, the inputs 2 are connected with the control elements 26 via signal lines 6. The control elements 26 are connected with the outputs 4 via signal lines 8. In contrast to the switching elements 26 used in FIG. 1, all switching elements 26 are connected with two control lines 12, 14 as well as two hold lines 16 and 28. As described in FIG. 1, both control lines 12 and 14 serve for application of the switching voltage on the switching element 26. In contrast to FIG. 1, the hold voltage is applied via both hold lines 16 and 28 rather than via the single hold line 16 and the signal line 8. A path completely separate from the RF path thereby results for the direct voltage signal of the hold voltage. The remaining design and the functionality of the switching matrix are identical with those in FIG. 1.

FIG. 4 shows an exemplary embodiment of a switching element 26 as it is used in the switching matrix in FIG. 3. Analogous to FIG. 2, two contacts 120 and 122, a switch contact 124 and a hold contact 126 with corresponding contacts 134 and 136 situated on the substrate 128 as well as the switch contact 130 and the hold contact 132 are located on a switch tongue 118. In contrast to the embodiment described in FIG. 2, in this variant the signal input 102 of the switching element 26 is directly connected with the contact 122 via a conductor 148 and is thus completely separate from the switching voltage and the hold voltage. Switching matrices populated with such switching elements 26 can consequently also be used for transfer of direct voltage signals. In addition to the hold connection 110 already described in connection with FIG. 2, a further hold connection 150 is provided for feed of the hold voltage, which hold connection 150 is connected with hold contact 126 on the switch tongue 118 via the conductor 116, the contacts 134 and 120 and the conductor 142. In this embodiment, the signal output 104 is connected with the contact 136 via a conductor 152.

As a further embodiment (not shown), the signal input 102 can be connected with the signal output 104 via a further contact on the movable end 118a of the switch tongue 118 in a manner comparable to the second variant in FIG. 2. Instead of the two contacts 120 and 122, a further contact would inasmuch be required on the substrate 128 as well as the two contacts 134 and 136. The functionality and programming of a switching matrix with the switching elements described here is wholly analogous to the exemplary embodiments described in FIG. 1 and FIG. 2.

Although modifications and changes may be suggested by those skilled in the art, it is the intention of the inventor to embody within the patent warranted hereon all changes and modifications as reasonably and properly come within the scope of his contribution to the art.

I claim as my invention:

1. A switching matrix comprising:
a plurality of inputs;
a plurality of outputs;
a plurality of individually controllable switching elements connected between said plurality of inputs and said plurality of outputs;
a plurality of control lines of which two control lines are connected to each of said switching elements for supplying respective control signals to that switching element to cause a change of state of said switching element to connect one of said inputs to one of said outputs; and
a plurality of hold lines, of which at least one hold line is connected to each of said switching elements to apply a hold signal to that switching element, after said change of state of that switching element, to maintain that switching element in the changed stated.

2. A switching matrix as claimed in claim 1 wherein each of said switching elements comprises a signal input and a signal output, and wherein said switching matrix comprises a first set of signal lines respectively connected between said plurality of inputs and the respective signal inputs of said switching elements, and a second set of signal lines respectively connected between said plurality of outputs and the respective signal outputs of said switching elements.

3. A switching matrix as claimed in claim 2 wherein said switching elements are disposed in rows and columns.

4. A switching matrix as claimed in claim 3 wherein each of said switching elements comprises a first control connection and a second control connection, and wherein control lines in a first portion of said plurality of control lines are respectively connected to the respective first control connections of switching elements in said rows, and wherein control lines in a second portion of said plurality of control lines are respectively connected with the respective second control connections of the switching elements in said columns, and wherein each switching element further has a hold connection connected to said at least one hold line.

5. A switching matrix as claimed in claim 4 wherein each of said switching elements comprises a micro-electromechanical switch that is actuatable to change the state of that switching element.

6. A switching matrix as claimed in claim 5 wherein each micro-electromechanical switch comprises a movable switch tongue connected between the signal input and the signal output of the switching element in which the micro-electromechanical switch is disposed.

7. A switching matrix as claimed in claim 6 wherein each switching element comprises a switching contact on said switch tongue connected to one of said first or second control connections.

8. A switching matrix as claimed in claim 7 wherein each switching element comprises a substrate to which said switch tongue is movably mounted, and a further switching contact disposed on said substrate beneath the switching contact on said switch tongue, said further switching contact being connected to the other of said first or second control connections.

9. A switching matrix as claimed in claim 8 comprising a feed line, connected via respective feed connections, to all signal lines in one of said first set of signal lines or said second set of signal lines, said feed line being at a hold voltage and said hold voltage being applied to the respective switching elements across said hold line and a signal line in the set of signal lines connected to said feed line.

10. A switching matrix as claimed in claim 9 wherein each feed connection comprises a coil.

11. A switching matrix as claimed in claim 10 wherein each feed connection comprises a connection to a reference potential through a capacitor.

12. A switching matrix as claimed in claim 9 wherein each switching element comprises:
a hold contact on said switch tongue connected to said input connection; and
a hold contact on said substrate disposed below said hold contact on said switch tongue, and connected to said hold connection.

13. A switching matrix as claimed in claim 9 wherein each switching element comprises:
a hold contact on said switch tongue;
a hold contact on said substrate disposed below said hold contact on said switch tongue and connected to said hold connection;
a first substrate contact on said substrate connected to said input connection;
a second substrate contact on said substrate connected to said output connection;
a first tongue contact disposed at a movable end of said switch tongue and disposed above said first substrate contact;
a second tongue contact disposed at said movable end of said switch tongue above said second substrate contact; and
said first and second tongue contacts being electrically connected together and to said hold contact on said switch tongue.

14. A switching matrix as claimed in claim 8 wherein said hold connection is a first hold connection, and wherein each switching element comprises a second hold connection, and wherein said plurality of hold lines comprise a first set of hold lines respectively connected to the respective first hold connection of the switching elements and a second set of hold lines respectively connected to the respective second hold connection of said switching elements, with a hold voltage being applied, for each switching element, across a hold line in the first set of hold lines and a hold line in the second set of hold lines, to maintain the switching element to which the hold voltage is applied in said changed state.

15. A switching matrix as claimed in claim 14 wherein each switching element comprises:
a hold contact on said switch tongue;
a hold contact on said substrate disposed below said hold contact on said switch tongue and connected to one of said first or second hold connections;
a first substrate contact disposed on said substrate and connected to said output connection;
a second substrate contact disposed on said substrate and connected to the other of said first or second hold connections;
a first tongue contact disposed at a movable end of said switch tongue above said first substrate contact, and connected to said input connection; and
a second tongue contact disposed at said movable end of said switch tongue above said second substrate contact and electrically connected to said hold contact on said switch tongue.
